(19) United States
(12) Patent Application Publication
(10) Pub. No.: US 2022/0289992 A1
(43) Pub. Date: Sep. 15, 2022

(54) Ink Composition For Ink Jet Recording And Coloring Material Dispersion Liquid

(71) Applicant: Seiko Epson Corporation, Tokyo (JP)

(72) Inventor: Hajime KAKISHITA, Shiojiri (JP)

(21) Appl. No.: 17/692,287

(22) Filed: Mar. 11, 2022

(30) Foreign Application Priority Data
Mar. 12, 2021 (JP) 2021-039994

(51) Int. Cl. C09D 11/102; C09D 11/328; C08G 18/42; C08G 18/76; C08G 18/10; C08L 75/04; D06P 5/30

(52) U.S. Cl. CPC C09D 11/102; C09D 11/328; C08G 18/4213; C08G 18/4216; C08G 18/4219; C08G 18/7621; C08G 18/10; C08L 75/04; D06P 5/30; C08L 2205/18

(57) ABSTRACT

An ink composition for ink jet recording includes resin particles of a urethane resin colored with a disperse dye, and the acid value of the urethane resin is 1 KOHmg/g or more and less than 100 KOHmg/g.

The present application is based on, and claims priority from JP Application Serial Number 2021-039994, filed Mar. 12, 2021, the disclosure of which is hereby incorporated by reference herein in its entirety.

### BACKGROUND

### 1. Technical Field

The present disclosure relates to an ink composition for ink jet recording and a coloring material dispersion liquid.

### 2. Related Art

Printing has been performed on polyester fabrics by an ink jet method using an ink for ink jet containing a sublimation dye having sublimability and a disperse dye.

Examples of such a textile printing method include a direct printing method of applying an ink to a recording medium to be dyed and then dyeing with a dye by heat treatment such as steaming or the like, and a thermal transfer printing method of applying a dye ink to an intermediate transfer medium and then thermally sublimation-transferring the dye from the intermediate transfer medium side to a recording medium to be dyed.

JP-A-10-114865 discloses, as a method excluding dyeing and transfer among the dyeing processes described above, a method for printing on a recording medium such as a polyester fabric, a cotton fabric, or the like by an ink jet method using an ink for ink jet recording, which contains a disperse dye in polyester fine particles.

However, the ink described in JP-A-10-114865 has a problem with storage stability of the ink because the dye is dispersed with a dispersant. In addition, the recording methods described in JP-A-10-114865 and WO2016/027835 easily cause a lack of flexibility of a coating film because of the use of only polyester resin particles. Therefore, when the flexible recording medium is printed and bent, there is a problem of cracking the coating film. That is, there is demand for an ink composition for ink jet recording and a coloring material dispersion liquid, which have excellent storage stability and form a coating film having improved flexibility.

### SUMMARY

According to an aspect of the present disclosure, an ink composition for ink jet recording includes resin particles of a urethane resin colored with a disperse dye, the urethane resin having an acid value of 1 KOHmg/g or more and less than 100 KOHmg/g.

According to an aspect of the present disclosure, a coloring material dispersion liquid includes resin particles of a urethane resin colored with a disperse dye, the urethane resin having an acid value of 1 KOHmg/g or more and less than 100 KOHmg/g.

### DESCRIPTION OF EXEMPLARY EMBODIMENTS

### 1. Coloring Material Dispersion Liquid

A coloring material dispersion liquid according to an embodiment of the present disclosure contains resin particles of a urethane resin colored with a disperse dye, water, and other components. In the coloring material dispersion liquid, the component such as the resin particles is dispersed in a medium such as water or the like. The coloring material dispersion liquid is applied to an ink composition for ink jet recording described later. The ink composition for ink jet recording can be applied to recording by using an inkjet method on a plurality of types of recording media such as paper and the like as well as fabrics of cotton and polyester. Each of the components contained in the coloring material dispersion liquid is described below. In the description below, the ink composition for ink jet recording is also simply referred to as the “ink”.

### 1. 1. Resin Particles

The resin particles contain the urethane resin and the disperse dye. In the resin particles, molecules of the disperse dye are dispersed in the resin particles composed of the urethane resin as a base material.

The average particle diameter of the resin particles is preferably 30 nm or more, more preferably 40 nm or more, and still more preferably 50 nm or more. Also, the average particle diameter is preferably 500 nm or less, more preferably 400 nm or less, and still more preferably 300 nm or less.

When the resin particles have an average particle diameter within the range described above, the resin particles are hardly sedimented, and storage stability is improved. Thus, the coating film formed by using the ink by an ink jet method is improved in compactness of the resin particles forming the coating film. In the description below, the coating film formed from the ink composition for ink jet recording is also simply referred to as the “coating film”

In the present specification, the average particle diameter represents a particle size distribution (50%) based on scattered light intensity. The average particle diameter can be determined by a scattering intensity distribution. For example, ELSZ-1000 (manufactured by Otsuka Electronics Co., Ltd.) can be applied to measurement of the average particle diameter.

### 1. 1. 1. Urethane Resin

The urethane resin contains polyester polyol, isocyanate, and another polyol as raw materials and can be produced by polymerizing these materials. Herein, the urethane resin is an anionic resin having an acid value.

Among these materials, the polyester polyol is particularly preferably contained. Thus, the color development of the coating film is improved by using the polyester polyol generally easily dyed with the disperse dye. Also, fixability is improved during printing on a polyester fabric and paper, and thus cracking more hardly occurs in the coating film.

The acid value of the urethane resin is preferably 1 KOHmg/g or more, more preferably 3 KOHmg/g or more, and still more preferably 5 KOHmg/g or more. Also, the acid value is preferably less than 100 KOHmg/g, more preferably less than 80 KOHmg/g, and still more preferably less than 60 KOHmg/g.

When the urethane resin has an acid value within the range described above, the resin particles having a narrow average particle diameter distribution can be produced, thereby improving storage stability.

### 1. 1. 1. 1. Polyester Polyol

The polyester polyol is produced as a precursor of the urethane resin. The polyester polyol contains a dibasic acid and a tribasic acid as raw materials, and is produced by polymerizing these materials.

A polyol is a monomer component having two or more hydroxyl groups as functional groups. Examples of the polyol include ethylene glycol, diethylene glycol, triethylene glycol, neopentyl glycol, propylene glycol, dipropylene glycol, butanediol, polyethylene glycol, 1,3-propanediol, 1,4-butanediol, 3-methyl-1,5-pentanediol, 1,4-cyclohexanedimethanol, isosorbide, erythritan, bisphenol A, hydrogenated bisphenol A, bisphenol A alkylene oxide adduct, and the like.

Among these, from the viewpoint of flexibility and color development of the coating film, ethylene glycol, diethylene glycol, bisphenol A, 3-methyl-1,5-pentanediol, and neopentyl glycol are particularly preferred.

The polyols can be used alone or in combination of two or more.

The dibasic acid is a monomer component having two carboxyl groups as functional groups. Also, an acid anhydride thereof and alkyl ester thereof, which has 1 or more and 4 or less carbon atoms, can be used.

Examples of the dibasic acid include phthalic acid, isophthalic acid, terephthalic acid, fumaric acid, maleic acid, adipic acid, sebacic acid, succinic acid, cyclohexane dicarboxylic acid, an acid anhydride thereof and alkyl ester thereof, which has 1 or more and 4 or less carbon atoms, and the like.

Among these, from the viewpoint of flexibility and color development of the coating film, dimethyl adipate, dimethyl terephthalate, and dimethyl isophthalate are particularly preferred.

The dibasic acids may be used alone or in combination of two or more.

The tribasic acid is a monomer component having three carboxyl groups as functional groups. Also, an acid anhydride thereof and alkyl ester thereof, which has 1 or more and 4 or less carbon atoms, can be used.

Examples of the tribasic acid include trimellitic acid, trimesic acid, and acid anhydrides thereof, and the like.

Among these, trimellitic acid and trimesic are particularly preferred. These can impart proper hydrophilicity to the urethane resin, and thus the resin particles having a narrower average particle diameter distribution can be produced, thereby contributing to an improvement in storage stability.

The tribasic acids may be used alone or in combination of two or more.

The polyester polyol of the present embodiment can be produced by copolymerizing the polyol, the dibasic acid, and the tribasic acid. The polymerization reaction is not particularly limited, but polycondensation and polyaddition can be used.

### 1. 1. 1. 2. Isocyanate

The isocyanate is a component having one isocyanate group as a functional group. Examples of the isocyanate include 2,4-tolylene diisocyanate, 2,6-tolylene diisocyanate, 4,4′-diphenylmethane diisocyanate, m-phenylene diisocyanate, p-phenylene diisocyanate, 3,3′-dimethyl-4,4′-biphenylene diisocyanate, 1,3-xylylene diisocyanate, 1,4-xylylene diisocyanate, 1,5-naphthalene diisocyanate, hexamethylene diisocyanate, isophorone diisocyanate, 4-methyl-1,3-cyclohexylene diisocyanate, 1,2-bis(isocyanatomethyl)cyclohexane, 1,3-bis(isocyanatomethyl)cyclohexane, 1,4-bis(isocyanatomethyl)cyclohexane, dicyclohexylmethane-4,4′-diisocyanate, and the like.

The isocyanate particularly preferably has two or more isocyanate groups. This increases the ratio of urethane bonds in the urethane resin and thus improves the strength of the coating film.

Among the isocyanates, particularly preferably used are one or more of hexamethylene diisocyanate, 1,3-bis(isocyanatomethyl)cyclohexane, dicyclohexylmethane-4,4′-diisocyanate, and isophorone diisocyanate. Therefore, the urethane resin can be made more flexible due to an increase in the degree of freedom of the molecular motion of the urethane resin, thereby improving the flexibility of the coating film.

### 1. 1. 1. 3. Other Polyol

The other polyol is a component used together with the polyester polyol when the urethane resin is synthesized. Examples of the other polyol include polytetramethylene glycol, dimethylolpropionic acid, and the like. The other polyol is not limited to these, and the polyols described as the raw material of the polyester polyol can also be used.

Among these, the other polyol is preferably dimethylolpropionic acid. This can impart proper hydrophilicity to the urethane resin and can produce the resin particles having a narrower average particle diameter distribution, thereby contributing to improvement in storage stability.

### 1. 1. 1. 4. Method for Producing Urethane Resin

The urethane resin of the present embodiment can be produced by copolymerizing the polyester polyol, the isocyanate, and the other polyol. The polymerization reaction is not particularly limited, and for example, polyaddition is used.

### 1. 1. 2. Disperse Dye

The ink and coloring material dispersion liquid of the embodiment contain the resin particles composed of the urethane resin as a base material, and the resin particles contain the disperse dye.

The disperse dye may be any dye as long as it is contained in the resin particles of the urethane resin, but the dye is preferably dispersed in the resin particles. The resin particles may contain the disperse dye in a dispersion state or the disperse dye may be partially exposed in the surfaces of the resin particles.

Therefore, flexibility is also imparted to the coating film by using the urethane resin being rich in flexibility. Thus, in recording on the recording medium having flexibility, followability of the coating film is improved even when the coating film is bent, resulting in little occurrence of cracking in the coating film.

The mass of the urethane resin in the resin particles is preferably 4 times or more and 30 times or less the mass of the disperse dye. Therefore, when the mass of the urethane resin is 4 times or more the mass of the disperse dye, the excessive disperse dye is decreased when the disperse dye is dispersed in the urethane resin, thereby enabling to improve color development of the coating film. While when the mass of the urethane resin is 30 times or less the mass of the disperse dye, the disperse dye is contained in a sufficient amount for the urethane resin, thereby enabling to improve color development of the coating film.

Examples of the disperse dye include C. I. (Color Index Generic Name) Disperse Yellow 1, 3, 4, 5, 7, 9, 13, 23, 24, 30, 33, 34, 42, 43, 44, 49, 50, 51, 54, 56, 58, 60, 61, 63, 64, 66, 68, 71, 74, 76, 79, 82, 83, 85, 86, 88, 90, 91, 93, 98, 99, 100, 104, 108, 114, 116, 118, 119, 122, 124, 126, 135, 140, 141, 149, 154, 160, 162, 163, 164, 165, 179, 180, 182, 183, 184, 186, 192, 198, 199, 201, 202, 204, 210, 211, 215, 216, 218, 224, 227, 231, and 232; C. I. Disperse orange 1, 3, 5, 7, 11, 13, 17, 20, 21, 25, 29, 30, 31, 32, 33, 37, 38, 42, 43, 44, 45, 46, 47, 48, 49, 50, 53, 54, 55, 56, 57, 58, 59, 61, 66, 71, 73, 76, 78, 80, 89, 90, 91, 93, 96, 97, 119, 127, 130, 139, 142; C. I. disperse Red 1, 4, 5, 7, 11, 12, 13, 15, 17, 27, 43, 44, 50, 52, 53, 54, 55, 56, 58, 59, 60, 65, 72, 73, 74, 75, 76, 78, 81, 82, 86, 88, 90, 91, 92, 93, 96, 103, 105, 106, 107, 108, 110, 111, 113, 117, 118, 121, 122, 126, 127, 128, 131, 132, 134, 135, 137, 143, 145, 146, 151, 152, 153, 154, 157, 159, 164, 167, 169, 177, 179, 181, 183, 184, 185, 188, 189, 190, 191, 192, 200, 201, 202, 203, 205, 206, 207, 210, 221, 224, 225, 227, 229, 239, 240, 257, 258, 277, 278, 279, 281, 288, 298, 302, 303, 310, 311, 312, 320, 324, 328, 362, and 364; C. I. Vat Red 41; C. I. Disperse Violet 1, 4, 8, 23, 26, 27, 28, 31, 33, 35, 36, 38, 40, 43, 46, 48, 50, 51, 52, 56, 57, 59, 61, 63, 69, and 77; C. I. Disperse Green 9; C. I. Disperse brown 1, 2, 4, 9, 13, and 19; C. I. Disperse Blue 3, 7, 9, 14, 16, 19, 20, 24, 26, 27, 35, 43, 44, 54, 55, 56, 58, 60, 62, 64, 71, 72, 73, 75, 79, 81, 82, 83, 87, 91, 92, 93, 94, 95, 96, 102, 106, 108, 112, 113, 115, 118, 120, 122, 125, 128, 130, 139, 141, 142, 143, 146, 148, 149, 153, 154, 158, 165, 167, 171, 173, 174, 176, 181, 183, 185, 186, 187, 189, 197, 198, 200, 201, 205, 207, 211, 214, 224, 225, 257, 259, 267, 268, 270, 284, 285, 287, 288, 291, 293, 295, 297, 301, 315, 330, 333, 359, and 360; C. I. Disperse Black 1, 3, 10, and 24; and the like.

The disperse dyes may be used alone or in combination of two or more.

### 1. 2. Water

Water functions as a dispersion medium for the resin particles. For example, pure water such as RO (Reverse Osmosis) water, distilled water, ion exchange water, or the like may be used.

### 1. 3. Other Component

The coloring material dispersion liquid may contain other components other than the above. Examples of the other components include a colorant other than the disperse dye, a resin material other than the urethane resin, various dispersants, an emulsifier and surfactant, a water-soluble organic solvent, a penetrant, a drying inhibitor, a pH adjuster, a chelating agent such as ethylenediamine tetraacetate salt, a preservative/anti-mold agent, an anti-rust agent, and the like. For example, a compound having an isothiazoline ring structure in its molecule can be preferably used as a preservative/anti-mold agent. In addition, the other components may be added when the ink is prepared from the coloring material dispersion liquid without being contained in the coloring material dispersion liquid.

### 1. 3. 1. pH Adjuster

Examples of the pH adjuster include, but are not particularly limited to, inorganic acids such as sulfuric acid, hydrochloric acid, nitric acid, and the like; inorganic bases such as lithium hydroxide, sodium hydroxide, potassium hydroxide, ammonia, and the like; organic acids such as adipic acid, citric acid, succinic acid, and the like; and organic bases such as triethanolamine, diethanolamine, monoethanolamine, tripropanolamine; and the like. The pH adjusters may be used alone or in combination of two or more.

### 1. 3. 2. Surfactant

Examples of the surfactant include, but are not particularly limited to, an anionic surfactant, a cationic surfactant, a nonionic surfactant, and the like.

Examples of the anionic surfactant include higher fatty acid salts such as sodium laurate, sodium stearate, sodium oleate, and the like; alky sulfate ester salts such as sodium dodecyl sulfate, sodium lauryl sulfate, sodium cetyl sulfate, sodium stearyl sulfate, sodium oleyl sulfate, and the like; higher alcohol sulfate ester salts such as sodium octyl alcohol sulfate ester, sodium lauryl alcohol sulfate ester, ammonium lauryl alcohol sulfate ester, and the like; aliphatic alcohol sulfate ester salts such as sodium acetyl alcohol sulfate ester, and the like; alkylbenzene sulfonate salts such as sodium dodecylbenzene sulfonate, sodium laurylbenzene sulfonate, sodium cetylbenzene sulfonate, sodium stearylbenzene sulfonate, sodium oleylbenzene sulfonate, and the like; alkylnaphthalene sulfonate salts such as sodium isopropylnaphthalene sulfonate and the like; alkyl diphenyl ether disulfonate salts such as sodium alkyl diphenyl ether disulfonate and the like; alkyl phosphate ester salts such as sodium lauryl phosphate, sodium stearyl phosphate, and the like; polyethylene oxide adducts of alky ether sulfate salts such as polyethylene oxide adduct of sodium lauryl ether sulfate, polyethylene oxide adduct of ammonium lauryl ether sulfate, polyethylene oxide adduct of triethanolamine lauryl surface, and the like; polyethylene oxide adducts of alkyl phenyl ether sulfate salts such as polyethylene oxide adduct of sodium nonyl phenyl ether sulfate and the like; polyethylene oxide adducts of alkyl ether phosphate salts such as polyethylene oxide adduct of sodium lauryl ether phosphate and the like; polyethylene oxide adducts of alkyl phenyl ether phosphate salts such as polyethylene oxide adduct of sodium nonyl phenyl ether phosphate and the like; perfluoroalkyl sulfonate salts; perfluoroalkyl carboxylate salts; perfluoroalkyl phosphate esters; and the like.

Examples of the cationic surfactant include quaternary ammonium salts such as lauryltrimethyl ammonium chloride, cetyltrimethyl ammonium chloride, cetyltrimethyl ammonium bromide, stearyltrimethyl ammonium chloride, behenyltrimethyl ammonium chloride, distearyldimethyl ammonium chloride, lanolin-derived quaternary ammonium salts, and the like; pyridinium salts such as lauryl pyridinium chloride, lauryl pyridinium bromide, cetyl pyridinium chloride, and the like; imidazolinium salts such as 2-stearly-hydroxyethyl-2-imidazoline derivatives and the like; amine salts such as N,N-diethyl-stearoamide-methylamine hydrochloride, polyoxyethylene stearylamine, and the like; and the like.

Examples of the nonionic surfactant include polyethylene glycol alkyl ethers such as polyethylene glycol cetyl ether, polyethylene glycol stearyl ether, polyethylene glycol oleyl ether, polyethylene glycol behenyl ether, and the like; polyethylene glycol polypropylene glycol alkyl ethers such as polyethylene glycol polypropylene glycol cetyl ether, polyethylene glycol polypropylene glycol decyl tetradecyl ether, and the like; polyethylene glycol alkyl phenyl ethers such as polyethylene glycol octyl phenyl ether, polyethylene glycol nonyl phenyl ether, and the like; polyethylene glycol fatty acid esters such as ethylene glycol monostearate, ethylene glycol distearate, diethylene glycol stearate, polyethylene glycol distearate, polyethylene glycol monolaurate, polyethylene glycol monostearate, polyethylene glycol monooleate, and the like; glycerin fatty acid esters such as glyceryl monomyristate, glyceryl monostearate, glyceryl monoisostearate, glyceryl distearate, glyceryl dioleate, and the like; sorbitan fatty acid esters such as sorbitan monopalmitate, sorbitan monostearate, sorbitan tristearate, sorbitan monooleate, sorbitan trioleate, and the like; polyethylene oxide adducts of glycerin fatty acid esters such as polyethylene oxide adduct of glyceryl monostearate, polyethylene oxide adduct of glyceryl monooleate, and the like; polyethylene oxide adducts of sorbitan fatty acid esters such as polyethylene oxide adduct of sorbitan monopalmitate, polyethylene oxide adduct of monostearate, polyethylene oxide adduct of sorbitan tristearate, polyethylene oxide adduct of sorbitan monooleate, polyethylene oxide adduct of sorbitan trioleate, and the like; polyethylene oxide adducts of sorbit fatty acid esters such as polyethylene oxide adduct of sorbit monolaurate, polyethylene oxide adduct of sorbit tetrastearate, polyethylene oxide adduct of sorbit hexastearate, polyethylene oxide adducts of sorbit tetraoleate, and the like; ethylene oxide adducts of castor oil and the like; 2,4,7,9-tetramethyl-5-decyne-4,7-diol and alkylene oxide adducts of 2,4,7,9-tetramethyl-5-decyne-4,7-diol; 2,4-dimethyl-5-decyne-4-ol and alkylene oxide adducts of 2,4-dimethyl-5-decyne-4-ol; perfluoroalkyl ethylene oxide adducts; polysiloxane-based compounds; polyether-modified organosiloxane; and the like.

The surfactants may be used alone or in combination of two or more.

### 1. 3. 3. Water-Soluble Organic Solvent

Examples of the water-soluble organic solvent include, but are not particularly limited to, glycerin; glycols such as ethylene glycol, diethylene glycol, triethylene glycol, propylene glycol, dipropylene glycol, 1,3-propanediol, 1,2-butanediol, 1,2-pentanediol, 1,2-hexanediol, 1,4-butanediol, 1,5-pentanediol, 3-methyl-1,5-pentanediol, 1,6-hexanediol, and the like; glycol monoethers such as ethylene glycol monomethyl ether, ethylene glycol monoethyl ether, diethylene glycol monomethyl ether, diethylene glycol monoethyl ether, propylene glycol monomethyl ether, propylene glycol monoethyl ether, dipropylene glycol monomethyl ether, dipropylene glycol monoethyl ether, triethylene glycol monomethyl ether, triethylene glycol monobutyl ether, and the like; nitrogen-containing solvents such as 2-pyrrolidone, N-methyl-2-pyrrolidone, N-ethyl-2-pyrrolidone, and the like; and alcohols such as methanol, ethanol, n-propyl alcohol, iso-propyl alcohol, n-butanol, 2-butanol, tert-butanol, iso-butanol, n-pentanol, 2-pentanol, 3-pentanol, tert-pentanol, and the like. The water-soluble organic solvents may be used alone or in combination of two or more.

### 1. 3. 4. Resin Material Other than Urethane Resin

The coloring material dispersion liquid may further contain another resin other than the urethane resin. Examples of the other resin include, but are not particularly limited to, an anionic resin, a cationic resin, and a nonionic resin. By containing such a resin, the resin particles can be fixed to the recording medium.

Examples of the cationic resin include, but are not particularly limited to, starch derivatives such as cationic starch and the like, a cationic urethane resin, a cationic olefin resin, and a cationic allylamine resin.

Examples of the anionic resin include cellulose derivatives such as carboxymethyl cellulose salts, viscose, and the like; and natural resins such as alginate salts, gum arabic, gum tragacanth, lignin sulfonate salts, and the like.

Examples of the nonionic resin include, but are not particularly limited to, an acrylic resin, a styrene-acrylic resin, a urethane resin, an ester resin, an olefin resin, and a vinyl acetate resin.

### 1. 4. Method for Preparing Coloring Material Dispersion Liquid

A method for preparing the coloring material dispersion liquid includes an emulsified suspension preparing step of preparing an emulsified suspension by mixing a first composition containing the disperse dye, the urethane resin, and the organic solvent, with a second composition containing water; and an organic solvent removing step of removing at least a portion of the organic solvent from the emulsified suspension. In addition, the other components may be mixed with the second composition or may be mixed after the organic solvent removing step.

First, the first composition containing the disperse dye, the urethane resin, and the organic solvent is prepared. The first composition may be prepared by mixing the components at one time or mixing the components in two or more divided stages.

For example, a kneaded product of the urethane resin and the disperse dye may be prepared, and then the kneaded product may be mixed with the organic solvent to dissolve or disperse the urethane resin and the disperse dye.

The organic solvent having a solubility of 0.1 g/100 g H₂O or more and 30 g/100 g H₂O or less in water at 25° C. can be preferably used.

Examples of such an organic solvent include ketones such as methyl ethyl ketone, methyl isopropyl ketone, and the like; and esters such as ethyl acetate, butyl acetate, isopropyl acetate, and the like. These can be used alone or in combination or two or more selected therefrom.

The organic solvent preferably dissolves or disperses the urethane resin and is preferably easily removed in the subsequent step. Therefore, the organic solvent preferably has a relatively low boiling point.

From this viewpoint, the organic solvent is preferably methyl ethyl ketone or ethyl acetate and more preferably methyl ethyl ketone.

### 1. 4. 1. Emulsified Suspension Preparing Step

In the emulsified suspension preparing step, the emulsified suspension is prepared by mixing the first composition with the second composition containing water.

The emulsified suspension prepared as described above has a state where a dispersoid containing the disperse dye, the urethane resin, and the organic solvent is dispersed in an aqueous dispersion medium.

The second composition may contain at least water, and, for example, pure water or a liquid containing a component other than water may be used.

A component other than water contained in the second composition is, for example, a basic component among the pH adjusters described above. The second composition containing the basic component enables neutralization of a carboxyl group possessed by the urethane resin, thereby improving hydrophilicity of the urethane resin.

The basic component may be mixed with the first composition before the first composition is mixed with the second composition. Even in this case, the effect described above can be obtained.

Thus, the urethane resin can be more preferably made hydrophilic, and the particle size distribution of the final resultant resin particles can be made narrower.

Examples of the basic component include inorganic bases and organic bases, and these can be used alone or in combination of two or more selected therefrom.

The first composition may be mixed with the second composition by, for example, supplying the second composition to the first composition or by suppling the first composition to the second composition. However, the second composition is preferably dropped to the first composition. This can more preferably produce the emulsified suspension.

In addition, the first composition is preferably mixed with the second composition by supplying the second composition to the first composition while stirring the first composition. This can more preferably produce the emulsified suspension.

### 1. 4. 2. Organic Solvent Removing Step

In the organic solvent removing step, at least a portion of the organic solvent is removed from the emulsified suspension. Thus, solid particles containing the disperse dye and the urethane resin are formed, which correspond the resin particles constituting the coloring material dispersion liquid.

The organic solvent removing step is performed by heating the emulsified suspension or placing the emulsified suspension in a reduced-pressure environment.

The coloring material dispersion liquid prepared by dispersing the solid resin particles, which are obtained in the organic solvent removing step and contain the disperse dye and the urethane resin, in the aqueous dispersion medium may be directly used as the ink of the embodiment of the disclosure or may be used as the ink of the embodiment of the disclosure after the coloring material dispersion liquid is mixed with the other components.

Also, the post-treatment step of washing, drying, and the like may be performed after the organic solvent removing step. Therefore, unnecessary components can be removed, and thus an ink having a composition more securely adjusted can be obtained.

The resin particles contained in the coloring material dispersion liquid obtained in the organic solvent removing step can be washed by, for example, producing a fine particle cake separated from the dispersion liquid constituting the coloring material dispersion liquid using a centrifugal separator, a filter press, a belt filter, or the like, stirring and dispersing the fine particle cake in water, and then further dehydrating the cake.

If required, drying treatment may be performed after dehydration. The drying treatment can be performed by using, for example, a mixing vacuum dryer such as a Ribocone-type dryer (manufactured by Okawara Mfg. Co., Ltd.), a Nauta mixer (manufactured by Hosokawa Micron Corporation), or the like, a fluidized bed-type dryer such as a fluidized bed dryer (manufactured by Okawara Mfg. Co., Ltd.), a vibratory fluidized bed dryer (manufactured by Chuo Kakouki Co., Ltd.), or the like.

When the dehydration treatment and drying treatment are performed, the coloring material dispersion liquid of the embodiment of the disclosure described above can be produced by mixing the washed resin particles with the other components containing at least water.

In the organic solvent removing step, the organic solvent contained in the emulsified suspension, particularly the organic solvent contained in the dispersoid of the emulsified suspension, may be at least partially removed and need not be completely removed. Even in such a case, the remaining organic solvent can be generally sufficiently removed by the post-treatment step of washing, drying, and the like. In addition, if it is a small amount, the organic solvent may remain in the finally prepared ink.

### 2. Ink Composition for Ink Jet Recording

The ink composition for ink jet recording according to the embodiment of the disclosure contains the coloring material dispersion liquid, water, and other components.

The content of the resin particles in the ink is preferably 10% by mass or more and 20% by mass or less relative to the total mass of the ink.

When the content of the resin particles in the ink is 10% by mass or more, the coating film can be formed by recording, and fixability to the recording medium can be improved. When the content of the resin particles in the ink is 20% by mass or less, the coating film has an ordered film structure, and thus strength of the coating film can be maintained.

### 2. 1. Water

The ink may further contain water. Examples of water include, but not particularly limited to, those described for the coloring material dispersion liquid.

### 2. 2. Other Components

The ink may further contain other components. Examples of the other components include, but not particularly limited to, those described for the coloring material dispersion liquid.

### 2. 2. 1. pH Adjuster

The ink may further contain a pH adjuster. Examples of the pH adjuster include, but not particularly limited to, those described for the coloring material dispersion liquid. The pH adjuster in the ink may be derived and mixed from the coloring material dispersion liquid or may be added separately during preparation of the ink.

### 2. 2. 2. Surfactant

The ink may further contain a surfactant. Examples of the surfactant, but not particularly limited to, those described for the coloring material dispersion liquid. The surfactant in the ink may be derived from the coloring material dispersion liquid and mixed or may be added separately during preparation of the ink.

### 2. 2. 3. Water-Soluble Organic Solvent

The ink may further contain a water-soluble organic solvent. Examples of the water-soluble organic solvent include, but not particularly limited to, those described for the coloring material dispersion liquid. The water-soluble organic solvent in the ink may be derived and mixed from the coloring material dispersion liquid or may be added separately during preparation of the ink.

In order to achieve more stable ejection of ink droplets by the ink jet method, the water-soluble organic solvent is preferably glycerin, glycols, or glycol monoethers, and particularly preferably diethylene glycol, propylene glycol, triethylene glycol monobutyl ether, or glycerin.

### 2. 3. Method for Producing Ink Composition for Ink Jet Recording

The ink composition for ink jet recording can be produced by mixing the components and sufficiently stirring the components so as to uniformly mix the components. If required, filtration may be performed after stirring.

### 3. Ink Jet Recording Apparatus

An ink jet recording apparatus is an apparatus which ejects and applies the ink to the recording medium. The ink can be ejected by an ink jet system using a known ink jet recording apparatus such as an ink jet printer. Usable examples of an ejection mechanism include a piezo system, a system in which the ink is ejected by the bubbles generated by heating the ink, and the like. Among these, the piezo system is preferred from the viewpoint of difficulty in denaturation of the ink composition for ink jet recording.

### 4. Recording Medium

The recording medium is properly selected according to applications of a printed matter formed using the ink and the recording medium. Examples of the material forming the recording medium include, but are not particularly limited to, polyvinyl chloride (PVC), polypropylene, polyethylene, polycarbonate, cellulose diacetate, cellulose triacetate, cellulose propionate, cellulose butyrate, cellulose acetate butyrate, cellulose nitrate, polyesters such as polyethylene terephthalate and the like, resin materials such as polyethylene, polystyrene, polypropylene, polycarbonate, polyvinyl acetal, polyamide, urethane resin, acrylic resin, and the like; surface-processed products of these; glass, paper, a metal, ceramic, leather, wood pottery, and fibers composed of at least one of these; various natural fibers, synthetic fibers, and semi-synthetic fibers such as silk, wool, cotton, hemp, polyester, polyamide, acryl, polyurethane, cellulose, linter, rayon, cupro, acetate, and the like; and the like. These can be used alone or in combination of two or more selected therefrom.

Examples of the form of the recording medium include a roll-shaped or cut-form sheet, a board, a cloth, and the like, and the recording medium having a three-dimensional form such as a spherical or rectangular parallelopiped form or the like may be used.

### 5. Recording Method

The recording method ejects the ink and applies the ink to the recording method by using the ink jet recording apparatus. In this case, a plurality of ink compositions for ink jet recording may be used together, or an ink other than the ink composition for ink jet recording may be combined.

According to the embodiment of the disclosure, the following effect can be obtained.

The ink can be improved in storage stability and flexibility of the coating film. That is, the ink having excellent storage stability and improving the flexibility of the coating film can be provided.

### 6. Examples and Comparative Examples

The present disclosure is described further detail below by showing examples and comparative examples. The present disclosure is not limited to these examples below.

Table 1 to Table 4 show the compositions relating to Example 1 to Example 12, Comparative Example 1, and Comparative Example 2. In detail, Table 1 is a table showing the compositions containing PE1 to PE6 and PEA used for the urethane resin. Table 2 is a table showing the compositions of resin 1 to resin 9 and resin B, which are urethane resins, and acid values. Table 3 is a table showing the compositions etc. of coloring material dispersion liquids 1 to 10 and coloring material dispersion liquids A and B, which contain resin 1 to resin 9, resin B, and polyester polyol PEA as the urethane resin. Table 4 is a table showing the compositions etc. of inks of Example 1 to Example 12 and Comparative Examples 1 and 2, which contain dispersion liquid 1 to dispersion liquid 10 and dispersion liquids A and B as the coloring material dispersion liquid. In Tables 1 and 2, a column with sign “-” without the description of a numerical value represents not containing. Also, in Table 1 to Table 4, the names used for some of the components are abbreviations. Each of the abbreviations is appended to the tables.

### 6. 1. Synthesis of Polyester Polyol

### 6. 1. 1. Synthesis of Copolymer PE1

In a 300 mL separable flask provided with a stirrer, 35 parts by weight of dimethyl adipate, 35 parts by weight of dimethyl terephthalate, 15 parts by weight of trimellitic acid, 17 parts by weight of ethylene glycol, 33 parts by weight of 3-methyl-1,5-pentanediol, and 4.6 parts by weight of tetrabutoxy titanium were added, heated at 180° C. for 3 hours in a nitrogen atmosphere and then gradually heated to 220° C. under reduced pressure while volatile components were removed by heating for a total of 5 hours, producing copolymer PE1.

### 6. 1. 2. Synthesis of Copolymers PE2 to 6 and PEA

Copolymers PE2 to PE6 and PEA were synthesized by the same method as for copolymer PE1 except that the types and amounts of the monomers used were changed so as to obtain the polyester polyol described in Table 1 below. In Table 1, the mixing amount of each of the components is represented by parts by weight.

TABLE 1

| | Dibasic acid | | | Tribasic acid | | Polyol | | | | |
|---|---|---|---|---|---|---|---|---|---|---|
| | AA | TPA | IPA | TMA | BTC | EG | DEG | BisA | MPD | NPG |
| PE1 | 34.8 | 35.0 | — | 14.7 | — | 16.8 | — | — | 33.1 | — |
| PE2 | — | 42.7 | 40.8 | — | 4.2 | — | 29.7 | — | — | 28.1 |
| PE3 | 19.2 | — | 19.4 | 50.4 | — | — | — | — | — | 57.3 |
| PE4 | 29.6 | 35.0 | — | — | 21.0 | — | — | 68.5 | 29.5 | — |
| PE5 | — | 38.8 | 36.9 | 12.6 | — | 16.8 | — | — | — | 29.2 |
| PE6 | — | 25.2 | 25.2 | 39.9 | — | — | — | — | 65.0 | — |
| PEA | 36.6 | 42.7 | — | — | 12.6 | — | 26.5 | — | 30.7 | — |

AA: Dimethyl adipate
TPA: Dimethyl terephthalate
IPA: Dimethyl isophthalate
TMA: Trimellitic acid
BTC: Trimesic acid
EG: Ethylene glycol
DEG: Diethylene glycol
BisA: Bisphenol A
MPD: 3-Methyl-1,5-pentanediol
NPG: Neopentyl glycol

### 6. 2. Synthesis of Urethane Resin

### 6. 2. 1. Synthesis of Resin 1

In a 500 mL separable flask provided with a stirrer and a dropping funnel, 100 parts by weight of PE1 was added, and 15 parts by weight of tolylene diisocyanate was dropped under heating at 80° C. in a nitrogen atmosphere. Then, the mixture was heated at 120° C. for 5 hours, and when the absorption derived from the isocyanate disappeared was confirmed by FT-IR (Fourier Transform Infrared Spectroscopy), the reaction was terminated. Consequently, resin 1 was produced. The acid value of the resin 1 measured by acid value measurement described later was 18 KOHmg/g.

### 6. 2. 2. Synthesis of Resin 2 to Resin 9 and Resin B

Resin 2 to resin 9 and resin B were synthesized by the same method as for the resin 1 except that the types and amounts of the monomers used were changed so as to obtain the urethane resin described in Table 2 below. In Table 2, the mixing amount of each of the components is represented by parts by weight.

TABLE 2

| | Polyester polyol | | | | | | Polyol | | Isocyanate | | | | | Acid |
|---|---|---|---|---|---|---|---|---|---|---|---|---|---|---|
| | PE1 | PE2 | PE3 | PE4 | PE5 | PE6 | PTMG | DMPA | TDI | HDI | HXDI | IPDI | HMDI | value |
| Resin | 100 | — | — | — | — | — | — | — | 15 | — | — | — | — | 18 |
| 1 | | | | | | | | | | | | | | |
| Resin | — | 100 | — | — | — | — | — | — | — | — | 16 | — | — | 5 |
| 2 | | | | | | | | | | | | | | |
| Resin | — | — | 100 | — | — | — | — | — | — | — | — | — | 22 | 81 |
| 3 | | | | | | | | | | | | | | |
| Resin | — | — | — | — | — | 100 | — | 5 | — | — | 22 | — | — | 63 |
| 4 | | | | | | | | | | | | | | |
| Resin | — | — | — | — | 100 | — | — | 10 | — | — | — | 32 | — | 42 |
| 5 | | | | | | | | | | | | | | |
| Resin | — | — | 100 | — | — | — | — | 5 | — | 19 | — | — | — | 85 |
| 6 | | | | | | | | | | | | | | |
| Resin | — | — | — | 100 | — | — | — | 5 | — | 19 | — | — | — | 40 |
| 7 | | | | | | | | | | | | | | |
| Resin | — | — | — | — | 100 | — | 100 | 10 | — | — | — | 52 | — | 26 |
| 8 | | | | | | | | | | | | | | |
| Resin | — | 100 | — | — | — | — | 100 | 5 | — | — | — | — | 53 | 12 |
| 9 | | | | | | | | | | | | | | |
| Resin | — | — | 100 | — | — | — | — | 60 | — | 80 | — | — | — | 128 |
| B | | | | | | | | | | | | | | |

PTMG: Polytetramethylene glycol 1000
DMPA: Dimethylolpropionic acid
TDI: Tolylene diisocyanate
HDI: Hexamethylene diisocyanate
HXDI: 1,3-Bis(isocyanatomethyl)cyclohexane
IPDI: Isophorone diisocyanate
HMDI: Dicyclohexylmethane-4,4′-diisocyanate

### 6. 2. 3. Acid Value Measurement

The acid value can be measured by dropping ethanolic potassium hydroxide to a solution prepared by dissolving the resultant resin in tetrahydrofuran and confirming the mass of potassium hydroxide required for neutralization relative to the mass of the resin used. For example, GT-200 (manufactured by Nittoseiko Analytech Co., Ltd.) can be applied to acid value measurement.

### 6. 3. Preparation of Coloring Material Dispersion Liquid

### 6. 3. 1. Preparation of Dispersion Liquid 1

In a 500 mL separable flask provided with a stirrer, 50 parts by weight of the resin 1, 50 parts by weight of ethyl acetate, 1 part by weight of Disperse Red 60, and 2.4 parts by weight of triethanolamine were added and stirred. Then, 100 parts by weight of pure water was added and mixed, and ethyl acetate was distilled off under reduced pressure, preparing dispersion liquid 1.

### 6. 3. 2. Preparation of Dispersion Liquid 2

In a 500 mL separable flask provided with a stirrer, 50 parts by weight of the resin 1, 50 parts by weight of methyl ethyl ketone, 1 part by weight of Disperse Red 60, and 2.4 parts by weight of triethanolamine were added and stirred. Then, 100 parts by weight of pure water was added and mixed, and methyl ethyl ketone was distilled off under reduced pressure, preparing dispersion liquid 2.

### 6. 3. 3. Preparation of Dispersion Liquids 3 to 10 and Dispersion Liquids A and B

Dispersion liquids 3 to 10 and dispersion liquids A and B were prepared by the same method as for the dispersion liquid 2 except that the type and amount of the resin used and the amounts of the solvent and disperse dye were changed so as to obtain the dispersion liquids shown in Table 3. In Table 3, the unit of the amount of each of the components used is parts by weight.

TABLE 3

| | | | | | | | | Mass of |
|---|---|---|---|---|---|---|---|---|
| | | | | | | Resin particle | | urethane resin |
| | Dispersion liquid composition | | | | | Average | | relative to |
| | | | | pH | Disperse | particle | | mass of |
| | Urethane resin | | Solvent | adjuster | dye | diameter | Concentration | disperse dye |
| | Type | | MEK | TEA | DR60 | [nm] | [% by mass] | [times] |
| Coloring | Resin 1 | 50 | 50 | 2.4 | 1.0 | 2375 | 42 | 50.00 |
| material | | | | | | | | |
| dispersion | | | | | | | | |
| liquid 1 | | | | | | | | |
| Coloring | Resin 1 | 50 | 50 | 2.4 | 1.0 | 150 | 48 | 50.00 |
| material | | | | | | | | |
| dispersion | | | | | | | | |
| liquid 2 | | | | | | | | |
| Coloring | Resin 2 | 30 | 70 | 0.4 | 8.0 | 370 | 20 | 3.75 |
| material | | | | | | | | |
| dispersion | | | | | | | | |
| liquid 3 | | | | | | | | |
| Coloring | Resin 3 | 50 | 50 | 10.8 | 1.5 | 115 | 40 | 33.30 |
| material | | | | | | | | |
| dispersion | | | | | | | | |
| liquid 4 | | | | | | | | |
| Coloring | Resin 4 | 50 | 100 | 8.4 | 15.0 | 280 | 34 | 3.30 |
| material | | | | | | | | |
| dispersion | | | | | | | | |
| liquid 5 | | | | | | | | |
| Coloring | Resin 5 | 30 | 70 | 3.4 | 0.5 | 37 | 25 | 60.00 |
| material | | | | | | | | |
| dispersion | | | | | | | | |
| liquid 6 | | | | | | | | |
| Coloring | Resin 6 | 50 | 50 | 11.3 | 3.0 | 98 | 43 | 16.70 |
| material | | | | | | | | |
| dispersion | | | | | | | | |
| liquid 7 | | | | | | | | |
| Coloring | Resin 7 | 50 | 50 | 5.3 | 5.0 | 480 | 22 | 10.00 |
| material | | | | | | | | |
| dispersion | | | | | | | | |
| liquid 8 | | | | | | | | |
| Coloring | Resin 8 | 50 | 50 | 3.5 | 2.0 | 243 | 37 | 25.00 |
| material | | | | | | | | |
| dispersion | | | | | | | | |
| liquid 9 | | | | | | | | |
| Coloring | Resin 9 | 30 | 70 | 1.0 | 6.0 | 85 | 35 | 5.00 |
| material | | | | | | | | |
| dispersion | | | | | | | | |
| liquid 10 | | | | | | | | |
| Coloring | PEA | 50 | 50 | 4.4 | 5.0 | 56 | 30 | 10.00 |
| material | | | | | | | | |
| dispersion | | | | | | | | |
| liquid A | | | | | | | | |
| Coloring | Resin B | 50 | 50 | 17.0 | 3.0 | 8223 | 41 | 16.70 |
| material | | | | | | | | |
| dispersion | | | | | | | | |
| liquid B | | | | | | | | |

MEK: Methyl ethyl ketone
TEA: Triethanolamine
DR60: C. I. Disperse Red 60

### 6. 3. 4. Measurement of Solid Content Concentration

The solid content concentration was measured by, for example, weighing 1 g of each of the coloring material dispersion liquid and ink and determining the ratio of the weight remaining after freeze drying to the weight before freeze drying.

### 6. 4. Preparation of Ink Composition for Ink Jet Recording

Inks of Example 1 to Example 12 and Comparative Example 1 and Comparative Example 2 were prepared according to Table 4. In the column “Ink composition” of Table 4, the unit of the amount of each of the components used is % by mass.

TABLE 4

| | | | | | | | | | | | Solid |
|---|---|---|---|---|---|---|---|---|---|---|---|
| | Ink composition | | | | | | | | | | content |
| | Dispersion liquid | | Surfactant | | Water-soluble organic solvent | | | | Pure | | mass |
| | Type | | BYK348 | E1010 | PG | BTG | GL | DEG | water | Total | (%) |
| Example 1 | Dispersion | 50.0 | 0.5 | 0.5 | 5.0 | 5.0 | 7.0 | 5.0 | Balance | 100.0 | 20 |
| | liquid 1 | | | | | | | | | | |
| Example 2 | Dispersion | 50.0 | 0.5 | 0.5 | 5.0 | 5.0 | 7.0 | 5.0 | Balance | 100.0 | 25 |
| | liquid 2 | | | | | | | | | | |
| Example 3 | Dispersion | 40.0 | 0.5 | 0.5 | 5.0 | 5.0 | 7.0 | 5.0 | Balance | 100.0 | 8 |
| | liquid 3 | | | | | | | | | | |
| Example 4 | Dispersion | 60.0 | 0.5 | 0.5 | 5.0 | 5.0 | 7.0 | 5.0 | Balance | 100.0 | 24 |
| | liquid 4 | | | | | | | | | | |
| Example 5 | Dispersion | 25.0 | 0.5 | 0.5 | 5.0 | 5.0 | 7.0 | 5.0 | Balance | 100.0 | 5 |
| | liquid 3 | | | | | | | | | | |
| Example 6 | Dispersion | 60.0 | 0.5 | 0.5 | 5.0 | 5.0 | 7.0 | 5.0 | Balance | 100.0 | 29 |
| | liquid 2 | | | | | | | | | | |
| Example 7 | Dispersion | 40.0 | 0.5 | 0.5 | 5.0 | 5.0 | 7.0 | 5.0 | Balance | 100.0 | 14 |
| | liquid 5 | | | | | | | | | | |
| Example 8 | Dispersion | 50.0 | 0.5 | 0.5 | 5.0 | 5.0 | 7.0 | 5.0 | Balance | 100.0 | 13 |
| | liquid 6 | | | | | | | | | | |
| Example 9 | Dispersion | 40.0 | 0.5 | 0.5 | 5.0 | 5.0 | 7.0 | 5.0 | Balance | 100.0 | 17 |
| | liquid 7 | | | | | | | | | | |
| Example 10 | Dispersion | 30.0 | 0.5 | 0.5 | 5.0 | 5.0 | 7.0 | 5.0 | Balance | 100.0 | 7 |
| | liquid 8 | | | | | | | | | | |
| Example 11 | Dispersion | 50.0 | 0.5 | 0.5 | 5.0 | 5.0 | 7.0 | 5.0 | Balance | 100.0 | 19 |
| | liquid 9 | | | | | | | | | | |
| Example 12 | Dispersion | 50.0 | 0.5 | 0.5 | 5.0 | 5.0 | 7.0 | 5.0 | Balance | 100.0 | 18 |
| | liquid 10 | | | | | | | | | | |
| Comparative | Dispersion | 50.0 | 0.5 | 0.5 | 5.0 | 5.0 | 7.0 | 5.0 | Balance | 100.0 | 15 |
| Example 1 | liquid A | | | | | | | | | | |
| Comparative | Dispersion | 50.0 | 0.5 | 0.5 | 5.0 | 5.0 | 7.0 | 5.0 | Balance | 100.0 | 21 |
| Example 2 | liquid B | | | | | | | | | | |

BYK-348: Silicone-based surfactant, manufactured by BYK Chemie Co., Ltd.
E1010: Olfine E1010 acetylene glycol-based surfactant, manufactured by Nissin Chemical Industry Co., Ltd.
PG: Propylene glycol
BTG: Triethylene glycol monobutyl ether
GL: Glycerin
DEG: Diethylene glycol

Example 1 is an ink prepared by using the dispersion liquid 1, and has a relation that the dispersion liquid 1 uses the resin 1 and the resin 1 uses the PE1.

Example 2 uses the dispersion liquid 2 and has a relation that the dispersion liquid 2 uses the resin 1 and the resin 1 uses the PE1. The dispersion liquid 2 is at a level where the particle diameter is smaller than the dispersion liquid 1.

Example 3 uses the dispersion liquid 3 and has a relation that the dispersion liquid 3 uses the resin 2 and the resin 2 uses the PE2. The resin 2 or after is at a where it uses one of hexamethylene diisocyanate, 1,3-bis(isocyanatomethyl)cyclohexane, dicyclohexylmethane-4,4′-diisocyanate, and isophorone diisocyanate.

Example 4 uses the dispersion liquid 4 and has a relation that the dispersion liquid 4 uses the resin 3 and the resin 3 uses the PE3.

Example 5 uses the dispersion liquid 3 and has a relation that the dispersion liquid 3 uses the resin 2 and the resin 2 uses the PE2.

Example 6 uses the dispersion liquid 2 and has a relation that the dispersion liquid 2 uses the resin 1 and the resin 1 uses the PE1. Hereinafter, the resin is at a level where it uses dimethylolpropionic acid.

Example 7 uses the dispersion liquid 5 and has a relation that the dispersion liquid 5 uses the resin 4 and the resin 4 uses the PE6.

Example 8 uses the dispersion liquid 6 and has a relation that the dispersion liquid 6 uses the resin 5 and the resin 5 uses the PE5.

Example 9 uses the dispersion liquid 7 and has a relation that the dispersion liquid 7 uses the resin 6 and the resin 6 uses the PE3.

Example 10 uses the dispersion liquid 8 and has a relation that the dispersion liquid 8 uses the resin 7 and the resin 7 uses the PE4.

Example 11 uses the dispersion liquid 9 and has a relation that the dispersion liquid 9 uses the resin 8 and the resin 8 uses the PE5.

Example 12 uses the dispersion liquid 10 and has a relation that the dispersion liquid 10 uses the resin 9 and the resin 9 uses the PE2.

Comparative Example 1 uses the dispersion liquid A and has a relation that the dispersion liquid A uses polyester polyol PEA. Comparative Example 1 has a level using polyester polyol itself not being converted to the urethane resin.

Comparative Example 2 uses the dispersion liquid B and has a relation that the dispersion liquid B uses the resin B and the resin B uses the PE3. Comparative Example 2 has a level using the resin B having an acid value of as high as 128 KOHmg/g.

### 6. 5. Evaluation

The ink of each of the examples and the comparative examples was evaluated as described below, and the evaluation results are shown in Table 5.

### 6. 5. 1. Storage Stability

In a 9 mL sample bottle, 5 g of the ink of each of the examples and the comparative examples was placed and allowed to stand at 60° C. for 120 hours. Then, the number of coarse particles was measured by the number of limited particles of 0.5 μm or more using FPIA-3000 (manufactured by Malvern Panalytical Co., Ltd.). Evaluation was made according to criteria below. It can be considered that the smaller the number of limited particles is, the more excellent the storage stability is.

A: The number of limited particles is less than 100,000.
B: The number of limited particles is 100,000 and less than 200,000.
C: The number of limited particles is 200,000 or more.

### 6. 5. 2. Flexibility

The ink of each of the examples and the comparative examples was ejected in a predetermined pattern toward MCPW paper (manufactured by Toppan Forms Co., Ltd.) as a recording medium using recording apparatus M105 (manufactured by Seiko Epson Corporation). The coating film in a colored portion of the resultant recorded matter was slightly bent obliquely at 45 degrees, and a pressure roller was rolled at a constant speed for one reciprocation to form a fold. The fold of the recording medium was widened and wiped off with clean absorbent cotton for one reciprocation. In this case, the bent portion in the colored portion was observed and evaluated according to criteria below. It can be considered that the smaller the number of lines produced by falling of the ink in the bent portion is, the more excellent the flexibility of the coating film is.

A: The lines produced by falling of the ink cannot be confirmed.
B: The lines produced by falling of the ink can be partially confirmed.
C: The series of lines produced by falling of the ink can be confirmed.

### 6. 5. 3. Color Development

The ink of each of the examples and the comparative examples was ejected in a predetermined pattern toward MCPW paper (manufactured by Toppan Forms Co., Ltd.) as a recording medium using recording apparatus M105 (manufactured by Seiko Epson Corporation). Then, in the resultant recorded matter, the OD (Optical Density) value of a portion, where in the recorded matter, the ink was applied, was determined by using i1 (manufactured by X-Rite, Inc.) and evaluated according to criteria below. It can be considered that the larger the OD value is, the more excellent the color development is.

A: The OD value is 1.2 or more.
B: The OD value is 1.0 or more and less than 1.2.
C: The OD value is 0.7 or more and less than 1.0.
D: The OD value is 0.5 or more and less than 0.7.
E: The OD value is less than 0.5.

### 6. 5. 4. Fixability

The ink of each of the examples and the comparative examples was ejected in a predetermined pattern toward a cotton fabric as a recording medium using recording apparatus PX-M860F (manufactured by Seiko Epson Corporation). The resultant recorded matter was washed with hot water of 40° C. in a standard mode of a household washing machine (drum-type washing dryer TW-Z9500L, manufactured by Toshiba Lifestyle Products & Services Corporation) using a washing detergent (Top Clear Liquid manufactured by Lion Corporation), and the rate of decrease in OD value of a dyed portion before and after washing was determined and evaluated according to criteria below. It can be considered that the lower the OD value is, the more excellent the fixability of the dyed portion with the ink to the recording medium is.

A: The rate of decrease in OD value is less than 3%.
B: The rate of decrease in OD value is 3% or more and less than 10%.
C: The rate of decrease in OD value is 10% or more and less than 30%.
D: The rate of decrease in OD value is 30% or more and less than 50%.
E: The rate of decrease in OD value is 50% or more.

TABLE 5

| | | | | | | | | | | | | | Compar- | Compar- |
|---|---|---|---|---|---|---|---|---|---|---|---|---|---|---|
| | | | | | | | | | | | | | ative | ative |
| | Ex- | Ex- | Ex- | Ex- | Ex- | Ex- | Ex- | Ex- | Ex- | Ex- | Ex- | Ex- | Ex- | Ex- |
| | ample | ample | ample | ample | ample | ample | ample | ample | ample | ample | ample | ample | ample | ample |
| | 1 | 2 | 3 | 4 | 5 | 6 | 7 | 8 | 9 | 10 | 11 | 12 | 1 | 2 |
| Storage | B | B | B | B | A | A | A | A | A | A | A | A | C | C |
| sta- | | | | | | | | | | | | | | |
| bility | | | | | | | | | | | | | | |
| Flex- | B | B | A | A | A | A | A | A | A | A | A | A | C | C |
| ibility | | | | | | | | | | | | | | |
| Color | D | D | C | C | C | D | D | D | A | A | A | A | E | D |
| devel- | | | | | | | | | | | | | | |
| opment | | | | | | | | | | | | | | |
| Flex- | D | D | C | C | D | D | B | B | A | B | A | A | E | E |
| ibility | | | | | | | | | | | | | | |

### 6. 5. 5. Summary of Evaluation Results

Table 5 indicates that in Examples 1, 2, 3, and 4, the storage stability of the inks of the examples is evaluated as “B”. In particular, in Examples 5, 6, 7, 8, 9, 11, and 12, it is evaluated as “A”. Also, in Examples 1 and 2, the flexibility of the coating films of the inks of the examples is evaluated as “B”, and in Examples 3 to 12, it is evaluated as “A”. This indicates that the inks of the examples are excellent in storage stability and flexibility.

In Examples 3, 4, and 5, the color development of the inks of the examples is evaluated as “C”, and in Examples 9, 10, 11, and 12, it is evaluated as “A”. Also, in Examples 7, 8, and 10, the fixability of the inks of the examples is evaluated as “B”, and in Examples 9, 11, and 12, it is evaluated as “A”. This indicates that the inks of the examples are easily improved in color development and fixability.

On the other hand, in both the comparative examples, the storage stability of the inks is evaluated as “C”, and the flexibility is evaluated as “C”. This indicates that storage stability and flexibility are hardly improved.

What is claimed is:

1. An ink composition for ink jet recording comprising:
resin particles of a urethane resin colored with a disperse dye,
wherein the acid value of the urethane resin is 1 KOHmg/g or more and less than 100 KOHmg/g.

2. The ink composition for ink jet recording according to claim 1,
wherein the urethane resin contains polyester polyol and isocyanate as raw materials.

3. The ink composition for ink jet recording according to claim 2,
wherein the isocyanate has two or more isocyanate groups as polymerizable functional groups.

4. The ink composition for ink jet recording according to claim 3,
wherein the isocyanate contains one or more of hexamethylene diisocyanate, 1,3-bis(isocyanatomethyl)cyclohexane, dicyclohexylmethane-4,4′-diisocyanate, and isophorone diisocyanate.

5. The ink composition for ink jet recording according to claim 2,
wherein the polyester polyol contains one or more of trimellitic acid and trimesic acid as raw materials.

6. The ink composition for ink jet recording according to claim 2,
wherein the urethane resin further contains a polyol as a raw material; and
the polyol contains dimethylolpropionic acid.

7. The ink composition for ink jet recording according to claim 1,
wherein the resin particles have an average particle diameter of 30 nm or more and 500 nm or less.

8. The ink composition for ink jet recording according to claim 1,
wherein the content of the resin particles is 10% by mass or more and 20% by mass or less relative to the total mass.

9. The ink composition for ink jet recording according to claim 1,
wherein the mass of the urethane resin is 4 times or more and 30 times or less the mass of the disperse dye.

10. A coloring material dispersion liquid comprising:
resin particles of a urethane resin colored with a disperse dye,
wherein the acid value of the urethane resin is 1 KOHmg/g or more and less than 100 KOHmg/g.
